(19) United States
(12) Patent Application Publication
(10) Pub. No.: US 2023/0138560 A1
(43) Pub. Date: May 4, 2023

(54) ELECTRONIC WATCHMAKER'S LOUPE, ELECTRONIC WATCHMAKER'S LOUPE ASSEMBLY AND METHOD FOR CARRYING OUT A CHECK OF A WATCH PRODUCT, IN PARTICULAR A WATCH MECHANISM

(71) Applicant: Richemont International SA, Villars-sur-Glâne (CH)

(72) Inventors: Antonio PALMISANO, Diessenhofen (CH); Raphael SPYCHER, Eschenz (CH); Angela COLUCCI, Schaffhausen (CH)

(21) Appl. No.: 17/913,387

(22) PCT Filed: Mar. 16, 2021
(86) PCT No.: PCT/EP2021/056692

§ 371 Date: Sep. 21, 2022

(30) Foreign Application Priority Data
Mar. 27, 2020 (CH) 00373/20

(51) Int. Cl. G02B 25/00; G02B 27/01; G02B 27/02

(52) U.S. Cl. CPC G02B 25/005; G02B 27/0172; G02B 27/027; G02B 2027/0138

(57) ABSTRACT

An electronic watchmaker magnifier, intended to observe a watchmaking product, in particular a watch mechanism, is provided with:
a magnifying objective lens, to observe the watchmaking product,
communication means, to receive data,
a display screen, to display the data,
a beam splitter, provided to simultaneously direct towards a user's eye at least one image of the watchmaking product coming from the magnifying objective lens and at least one image from the display screen.

The present invention generally relates to an electronic watchmaker magnifier, the electronic magnifier being intended to observe a watchmaking product, the watchmaking product being in particular a watch mechanism. The invention also relates to an electronic watchmaker magnifier assembly, the magnifier assembly being intended to observe a watchmaking product, the watchmaking product being in particular a watch mechanism. The invention relates to a method for performing a check on a watchmaking product, the watchmaking product being in particular a watch mechanism.

### TECHNICAL FIELD

Traditionally, a watchmaker observes the details of a watchmaking product by means of a watchmaker magnifier that he precisely adjusts against his eye. The watchmaker keeps the magnifier permanently blocked with his brow bone and the upper portion of his cheek. The different magnifiers on the market have for example magnifications ranging from 4× to 10×. The watchmaker observes the details of the watchmaking product to determine its origin, perform a visual check, but also to carry out an assembly, maintenance, cleaning or setting operation, or to repair the product.

The watchmaking product is in particular a watch with its mechanism and all its decorative portions, but can also be an article of jewellery, such as a jewel, with precious stones, for example diamonds or ornamental stones (malachite, opal, turquoise, pearl, mother-of-pearl, etc.).

However, as the user of the magnifier remains focused on his work of observation of the watchmaking product through the magnifier, he may immediately need other information to perform all his tasks. The user can remove the magnifier from his eye, consult information placed next to him on his workbench in the form of printed documents or on a computer screen. This operation of removing the magnifier and then replacing the magnifier at the level of the eye to continue the observation work will cause the user not only a loss of time, but also a visual fatigue. This fatigue occurs because of the focusing required when the user moves from the document consultation phase without the magnifier, to the observation phase with the magnifier, and vice versa.

### SUMMARY OF THE INVENTION

One aim of the present invention is to respond to the drawbacks of the prior art mentioned above and particularly, first of all, to allow a user to observe a watchmaking product and also to directly have access to data.

A first aspect of the invention relates to an electronic watchmaker magnifier, intended to observe a watchmaking product, in particular a watch mechanism, the electronic magnifier being provided with
a magnifying objective lens, to observe the watchmaking product,
communication means, to receive data,
a display screen, to display the data,
a beam splitter, provided to simultaneously direct towards a user's eye at least one image of the watchmaking product coming from the magnifying objective lens and at least one image from the display screen.

In other words, the user will be able to directly and continuously see the watchmaking product he is observing, and simultaneously data that will appear on the watchmaking product he is observing. The data in the form of one or several image(s) are seen by the eye of the user and superimposed in pop-up on the image(s) of the watchmaking product. The data are received by the electronic magnifier thanks to the communication means.

Advantageously, the electronic magnifier can further comprise an acquisition camera, to acquire at least one image of the watchmaking product, the communication means being provided to send to a remote user the image of the watchmaking product acquired by the acquisition camera, the beam splitter being provided to simultaneously direct towards the acquisition camera at least one image of the watchmaking product coming from the magnifying objective lens and at least one image from the display screen.

Advantageously, the invention relates to an electronic watchmaker magnifier, intended to observe a watchmaking product, in particular a watch mechanism, the electronic magnifier being provided with:
a magnifying objective lens, to observe the watchmaking product
communication means, to receive data,
an acquisition camera, to acquire at least one image of the watchmaking product,
a beam splitter, provided to simultaneously direct towards a user's eye and towards the acquisition camera at least one image of the watchmaking product coming from the magnifying objective lens.

The user will thus observe the watchmaking product, but thanks to the camera, he will also be able to simultaneously send to a user located remotely an image or a continuous stream of images, known as “streaming” of the observed product. The remote user may be in the same room and right next to the user, or may be thousands of kilometers away from the room. In addition, thanks to the camera, the user will also be able to send to the user located remotely the image or the continuous stream of images, known as “streaming” of the observed product, and simultaneously the data in the form of one or several superimposed image(s) advantageously located on the optical axis: wearer's eye—electronic magnifier—watchmaking product.

The possible uses of the electronic magnifier according to the invention can be numerous. By way of example, a possible use of the electronic magnifier may be commercial, a user who is a person in charge of the sale showing his customer(s) the details of the watchmaking product remotely. Another possible use of the electronic magnifier may be for teaching purposes, a user who is a master watchmaker showing students how the mechanism of the watchmaking product, which in this case is a watch, is mounted, how the mechanism works, or how to perform the upkeep, etc. Another possible use of the electronic magnifier can be for valuation purposes, a master jeweler showing his colleagues on site or remotely all the characteristics of a precious stone.

Advantageously, the beam splitter can comprise a semi-reflecting mirror to split the image of the display screen into a first refracted portion directed towards the camera and a second reflected portion directed towards the eye of the user, and/or to split the image of the watchmaking product coming from the magnifying objective lens, into a first refracted portion directed towards the eye of the user and a second reflected portion directed towards the acquisition camera.

Advantageously, the electronic magnifier can comprise lighting means for illuminating or lighting the watchmaking product. Particularly, lighting means can be provided in the form of a pierced disk or a ring coaxial with the magnifying objective lens. In other words, the electronic magnifier can be equipped with lighting means which surround the magnifying objective lens to light the watchmaking product without generating stray shadows.

Advantageously, the lighting means can be a light ring arranged to be removably mounted on or around the magnifying objective lens. It is possible to envisage a ¼ turn or bayonet type mounting, with integrated electrical contacts.

Advantageously, the electronic magnifier can comprise:
a support frame,
a secondary frame removably mounted on the support frame,
optical means, comprising at least the magnifying objective lens, mounted secured to the secondary frame,
   the support frame comprising a left interface and a right interface each arranged to receive the secondary frame, so as to position the magnifying objective lens facing a left eye or a right eye of the user wearing the electronic magnifier, with the secondary frame respectively received by the left interface or by the right interface of the support frame.

Advantageously, the secondary frame can have at least one symmetry. Consequently, the mounting on the left or right interface is easy.

Advantageously, the secondary frame can comprise setting means arranged to vary a relative position between the secondary frame and the support frame, so as to adjust relative to the user's eye a position of the optical means embedded on the secondary frame. It is possible to envisage a slide with a wheel acting on a precision screw. It is possible to provide a depth setting, and also a lateral and/or vertical setting.

Advantageously, the electronic magnifier can comprise means for receiving a corrective glass. Particularly, receiving means can be provided to removably fix a corrective glass between the watchmaking product to be observed and an eye of the user. Preferably, the receiving means are arranged to removably fix a corrective glass between the magnifying objective lens and an eye of the user. It can be provided to fix on the electronic magnifier one or several lens(es) and/or lens filter(s) by a mechanical device, preferably equipped with magnets, to possibly correct ametropia of the wearer. Ametropia is a refraction anomaly, an optical defect of the eye, for example myopia or astigmatism of the wearer, who can then use the electronic magnifier without his glasses.

In another embodiment, not represented in the figures, the electronic magnifier comprises a first optoelectronic device for the automated measurement of any anomaly in the refraction of the wearer by means of a device called auto-refractometer using, for example, an infrared beam to automatically determine the diopter, the measurement unit presented by the symbol D to quantify the extent of an ametropia. The diopter D is a unit of optical power or vergence known in ophthalmology which, once measured and quantified for a wearer, will be used to automatically set a second optoelectronic device of one or several lens(es) integrated into the electronic magnifier until the wearer has a clear vision of the product. This second adjustment device thus helps to increase the visual acuity of the wearer. The visual acuity, expressed or quantified in tenths (for example: 10/10, 8/10 etc.), describes the ability of the eye to distinguish between two distinct points, a particularly important ability in the field of watchmaking and jewelry. The visual acuity is therefore linked to the ocular partition power, which is based on the minimum angle of resolution (MAR). This first device integrates a diopter measuring auto-refractometer in combination with a second automatic lens adjustment device into the electronic magnifier to improve the vision of the wearer's eye.

Advantageously, the electronic magnifier can comprise a zoom objective lens of an optical device, whose magnification value can be freely set continuously or at several levels automatically by the wearer or a third party using mechanical or electromechanical (such as a switch or a continuous or multi-position rotary switch, etc.) or electronic (such as a touch screen, remote control, etc.) means to choose the desired magnification or as needed to observe the watchmaking product.

Advantageously, the electronic magnifier can comprise means for receiving a neutral glass or a filter glass without magnification characteristics that the wearer can choose according to his need to observe the watchmaking product or to present, for example, his watchmaking workshop or the production center.

According to a second aspect of the invention, an electronic watchmaker magnifier assembly, intended to observe a watchmaking product, in particular a watch mechanism, comprises:
a data processing unit, having data, and
the electronic magnifier, according to the first aspect of the invention,
the communication means of the electronic magnifier communicating with the data processing unit, to receive the data and/or to send to the data processing unit the image of the watchmaking product acquired by the acquisition camera.

Advantageously, the magnifier assembly can comprise means for controlling the electronic magnifier, the communication means of the electronic magnifier communicating with the controlling means. With such an accessory that connects to the electronic magnifier, for example of the computer mouse type, the user will be able to drive the magnifier while keeping a view of the watchmaking product. The user of the magnifier sees the command on the display screen of the electronic magnifier. By way of example, the command can be a pointer arrow, a screen on-off icon, setting of the screen brightness, etc.

Advantageously, the magnifier assembly can comprise means for recognizing a tool to be used with the watchmaking product, to select from the data concerning the watchmaking product at least one information relating to the tool, the communication means of the electronic magnifier communicating with the recognition means to receive the selected information relating to the tool, so as to display the information relating to the tool on the display screen of the electronic magnifier.

With such an accessory which connects to the electronic magnifier and which ensures the recognition of the tools concerning the watchmaking product, the user will immediately have information about the tool to be used to perform a particular task on the watchmaking product. In the case of the watch mechanism, the user of the magnifier sees the information concerning the right tool to use, while keeping his eye thereon and remaining focused on his watchmaking product. For example, the information about a specific screwdriver will be displayed, and the user will grab the appropriate screwdriver and unscrew a particular screw. Or the user will retighten a particular screw, with displayed information relating to the tightening torque recommended by the manufacturer.

Advantageously, the magnifier assembly can comprise means for recognizing at least one component of the watchmaking product, to select from data concerning the watchmaking product at least one information relating to the component, the communication means of the electronic magnifier communicating with the recognition means to receive the selected information relating to the component, so as to display the information relating to the component on the display screen of the electronic magnifier.

With such an accessory which connects to the electronic magnifier and which ensures the recognition of a component concerning the watchmaking product, the user will immediately have the information about the component to be used to perform a particular task on the watchmaking product by using the component. In the case of the watch mechanism, the user of the magnifier sees the information concerning the right component to use, while keeping an eye thereon and remaining focused on his watchmaking product. For example, in a step of mounting a watch mechanism, the information about a specific component will be displayed, and the user will grab the appropriate component, and mount it. Or the user will optimally mount a module integrating several components, with information displayed relating to the manufacturer's recommendations.

Advantageously, the magnifier assembly can comprise a device for measuring parameters concerning the watchmaking product. By way of example and in the case of a watch mechanism, the parameters can be the rate, the frequency, the amplitude of the oscillations, the power reserve, etc. If necessary, the watchmaker will be able to make the settings of the mechanism based on these parameters.

Advantageously, the data processing unit can comprise a computer-type machine connected with a server. The computer-type machine can be a personal computer, a smartphone, a connected watch (smartwatch), a tablet or any other type of portable accessory integrating computing and electronics (wearables).

Advantageously, the computer-type machine can be connected to an external computer network. The connection to the Internet allows the transmission of the images remotely.

Advantageously, the magnifier assembly can further comprise a wireless router, forming an interface between the communication means of the electronic magnifier, and/or the data processing unit and/or the recognition means and/or the measurement device.

Advantageously, the data can comprise in particular:
information identifying the watchmaking product, and/or
technical information about the watchmaking product, and/or
information identifying a subset of the watchmaking product, and/or
information identifying a component of the watchmaking product, and/or
information identifying a stage of mounting the watchmaking product.

Thus, data relating to the identity of the watchmaking product will be able to be displayed on the screen of the magnifier. In the case of the watch mechanism, the data such as, for example, all the references of the watch, including the date of manufacture and the watchmaker involved in the mounting, the reference number of the caliber, the references of the constituent modules, the images of CAD (computer-aided design), the mounting stage, are useful for the user of the magnifier. Other data, such as advantages and weaknesses of the caliber, particular points to be monitored can also be displayed. One or several of these data are displayed by being superimposed on the image of the observed watchmaking product.

According to another aspect of the invention, a method for performing a check on a watchmaking product, in particular a watch mechanism, comprises the steps consisting in:
observing the watchmaking product with an objective lens of an electronic magnifier,
acquiring at least one image of the watchmaking product with a camera of the electronic magnifier, and
sending the acquired image of the watchmaking product to a computer-type machine in the vicinity of the electronic magnifier.

This checking method with these steps allows a watchmaker with less knowledge to observe the watchmaking product with the electronic magnifier, to send the image or the stream of observed and acquired images and to request the assistance of a more experienced watchmaker to ensure maintenance or repairs, which is all the more useful if the watchmaking product is rare or complex.

Advantageously, the method can further comprise the step consisting in sending the acquired image of the watchmaking product to a second computer-type machine, remote from the computer-type machine in the vicinity of the electronic magnifier. Thanks to this step of the checking method, a watchmaker communicates remotely with one of his colleagues, by using software that allows the users to make telephone or video calls via the Internet, as well as screen sharing.

Advantageously, the method can further comprise the steps consisting in:
sending to a data processing unit the acquired image of the watchmaking product, the data processing unit being programmed to recognize the watchmaking product, by comparison between the acquired image of the watchmaking product and data concerning the watchmaking product, and
displaying the data concerning the watchmaking product on a display screen of the electronic magnifier.

Thanks to these steps of the checking method, automatic recognition of the watchmaking product will take place, all useful information stored in the data processing unit will be able to be displayed on the screen of the magnifier and be visible to the user in the superimposition with the watchmaking product.

Advantageously, the method can further comprise the steps consisting in:
recognizing a tool to be used with the watchmaking product, to generate at least one information relating to the tool, and
displaying the information relating to the tool generated on the display screen of the electronic magnifier.

Advantageously, the method can further comprise the steps consisting in:
recognizing at least one component of the watchmaking product, to generate at least one information relating to the component of the watch mechanism, and
displaying the information relating to the component of the watchmaking product generated on the display screen of the electronic magnifier.

### BRIEF DESCRIPTION OF THE FIGURES

Other characteristics and advantages of the present invention will appear more clearly upon reading the following detailed description of one embodiment of the invention given by way of non-limiting example and illustrated by the appended drawings, wherein:

FIG. 1 represents an exploded perspective view in transparency of an electronic magnifier according to the invention;

FIG. 2 represents a side view of the optoelectronic module of the magnifier of FIG. 1 and according to a first embodiment;

FIG. 3 represents a simplified side view of the optoelectronic module of the magnifier according to a second embodiment;

FIG. 4 represents an electronic watchmaker magnifier assembly according to a first embodiment; and

FIG. 5 represents an electronic watchmaker magnifier assembly according to a second embodiment;

FIG. 6 represents a third embodiment of an electronic magnifier;

FIG. 7 represents a detail of an optoelectronic module of the electronic magnifier of FIG. 6 in rear view.

### DETAILED DESCRIPTION

As shown in FIGS. 1-3, an electronic watchmaker magnifier 1 according to the invention is positioned by a user directly against his eye 2 and is used to observe a watchmaking product 3. FIGS. 1-3 here illustrate a magnifier intended to be positioned over the user's right eye. According to another embodiment, a magnifier of specific design would allow the user to position it either on his right eye or on his left eye. The user, who is a watchmaker, generally works with one eye 2 looking through the magnifier and one free eye. The free eye of the user allows identifying the different parts on the workbench and placing them in the work area (zoom area). The electronic magnifier 1 comprises an optoelectronic module 4, a headband 6, partially visible in exploded view in FIG. 1, and a power supply unit 7 placed at the back of the headband 6. The headband 6 is provided with adjusting means 8 to adjust the tightening of the electronic magnifier 1 around the user's head.

The power supply unit 7 supplies the optoelectronic module 4 via electric cables (not represented). It should be noted that the power supply, for example in the form of a rechargeable battery or cells, can also be placed in the optoelectronic module 4.

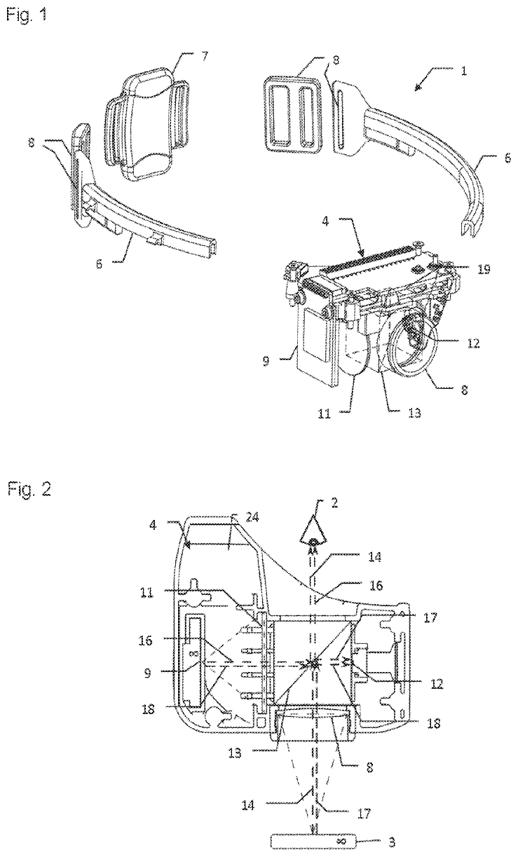

The optoelectronic module 4 according to the first embodiment of FIG. 1 and according to the second first embodiment of FIG. 2 comprises a magnifying objective lens, in this case in the form of a magnifying lens 8. The magnifying lens 8 is chosen so that the object to be observed, that is to say the watchmaking product 3, is at a focusing at infinity. This focusing has the advantage of not generating visual fatigue for the user, the crystalline lens of his eye 2 remaining focused at infinity. This focusing also has the advantage that the user retains a clear vision of the watchmaking product 3 that he is observing, even when he approaches or moves away slightly from the watchmaking product 3.

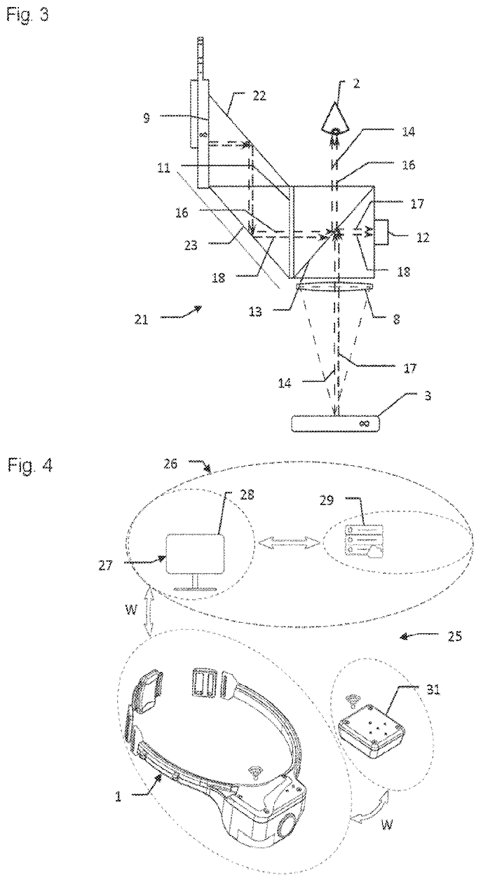

The optoelectronic module 4 comprises a display screen 9, an optical lens, for example of the Fresnel type 11, an image acquisition camera 12 and a beam splitter 13. The splitter 13 can be in the form a splitting prism or a semi-transparent mirror. The splitter 13 is provided to direct the images of the watchmaking product 3 coming from the magnifying lens 8 towards the eye 2 of the user (refracted portion or refracted beam indicated by the arrows 14 in FIGS. 2 and 3) and to simultaneously direct the images from the screen 9 to the user's eye 2 (reflected portion or reflected beam indicated by the arrows 16 in FIGS. 2 and 3). The splitter 13 is provided to direct the images of the watchmaking product 3 coming from the magnifying lens 8 towards the camera 12 (reflected portion or reflected beam indicated by the arrows 17 in FIGS. 2 and 3) and to simultaneously direct the images of the screen 9 towards camera 12 (refracted portion or refracted beam indicated by the arrows 18 in FIGS. 2 and 3).

The magnifying objective lens 8 can be exchanged for other objective lenses with different magnification factors, chosen according to what the user wishes and to the watchmaking product 2, while keeping a focusing at infinity. The electronic magnifier 1 has the advantage that the use of other objective lenses has no influence on the user and his visual fatigue or on the camera 12, the crystalline lens of his eye 2 remaining focused at infinity.

The screen 9 is provided to be at a focusing at infinity, due to the Fresnel lens 11, immediately in the vicinity of the splitter 13. The electronic magnifier 1 thus has the advantage that the crystalline lens of the eye 2 remains focused at infinity when the user both looks at the watchmaking product 3 and receives the images from the screen 9. The camera 12 can be provided with a fixed focal length, set with a focusing at infinity.

The optoelectronic module 4 comprises an electronic card or printed circuit 19 connected with a single-board computer. More particularly, the single-board computer has communication circuits for the communication means, circuits forming a storage memory and also a processor. The single-board computer also has an operating system that allows organizing the use of the resources, for example communication means or storage memory.

In the second embodiment represented in FIG. 3, the optoelectronic module 21 comprises two successive reflecting prisms at right angles 22 and 23. The first prism 22 is positioned against the screen 9. The second prism 23 is positioned between the first prism 22 and the Fresnel lens 11. The reflected beam 16 and the refracted beam 18 coming from the screen 9 first enter the first prism 22, are reflected by the first prism 22, leave the first prism 22, then enter the second prism 23, are reflected by the second prism 23, leave the second prism 23 and arrive at the Fresnel lens 11.

As the distance between the magnifying objective lens with the magnifying lens 8 and the watchmaking product 3 is very small in the case of the first embodiment of the electronic magnifier 1 with the optoelectronic module 4 of FIG. 2, the user's right hand could come into contact with the casing 24 of the optoelectronic module 21. This arrangement with two prisms 22 and 23 of the second embodiment of FIG. 3 allows modifying the position of the screen 9 relative to the other parts, magnifying objective lens 8, splitter 13 and camera 12, and moving this screen 9. The geometry of the casing of the optoelectronic module 21 of the second embodiment is thus modified and made more ergonomic. The user will be able to intervene more easily on the watchmaking product 3, especially since some maintenance or mounting operations are difficult to carry out, particularly in the case of a watch mechanism.

Data are displayed on the screen 9. These data are thus seen by the user superimposed with what he sees through the magnifying objective lens 8. These data are also acquired by the camera 12 superimposed with what the user sees through the magnifying objective lens 8.

For the electronic magnifier 2 to display these data on the screen 9 and/or for the data and the images seen by the user and transferred to the camera 12 can be transmitted, the electronic magnifier 1 is integrated into an electronic watchmaker magnifier assembly 25, according to a first embodiment represented in FIG. 4. The magnifier assembly 25 comprises a data processing unit 26. The data processing unit 26 comprises, for example, a computer-type machine 27, such as a personal computer. The computer-type machine 27 can also be a laptop computer, a smartphone, a tablet or a connected watch. The electronic magnifier 1 communicates with the unit 26, and more particularly with a computer-type machine 27, for example thanks to Wi-Fi wireless technology (Arrow W in FIG. 4). It should be noted that the electronic magnifier 1 can be driven via a smartphone.

The watchmaking product 3 seen by the user of the electronic magnifier 1, and the corresponding images transmitted by the acquisition camera 12, are displayed on a screen 28 of the computer-type machine 27. The data will also be displayed superimposed on the screen 28. This allows other users who are located in the immediate vicinity of the user of the electronic magnifier 1 to observe in streaming the watchmaking product 3 and the data directly on the screen 28.

When the computer-type machine 27 is connected to a computer network, for example Intranet or Internet, the images and the data transmitted by the acquisition camera 12 can be transmitted to one or several other processing units, personal computers, Laptop computers, smartphones and/or tablets, then located remotely. This allows other users who are remote from the user of the electronic magnifier 1 to observe in streaming the watchmaking product 3 directly on their own screen via a dedicated application or via an Internet browser.

It is possible that, thanks to this Internet connection, images or data coming from one or several other processing unit(s) located remotely may be displayed, superimposed or in the form of an insert, on the display screen 9 of the electronic magnifier 1. This Internet connection also has the advantage of allowing the user of the electronic magnifier 1 to be able to make a telephone or video call via the Internet, for example by using a Skype-type application. The user will also be able to make a conference call and share the screen 28, while keeping the electronic magnifier 1 in front of his eye 2, and remaining focused on the watchmaking product 3.

The unit 26 can comprise a remote server 29. The server 29 is used to store a large amount of information and data relating to a very large number of watchmaking products 3 and which have been stored beforehand. The computer-type machine 27 is connected and communicates with the server 29 for example by wired connection. The server 29 transfers data specific to the watchmaking product to the computer-type machine 27, which in turn transfers these same data to the communication means 19 of the electronic magnifier 1 and these data are displayed on the screen 9. The server 29 also serves to store the images received from the acquisition camera 12. It should be noted that the server can be a dedicated server or a cloud.

The magnifier assembly 25, according to the first embodiment of FIG. 4 can comprise one or several accessory(ies) 31 which connect(s) to the electronic magnifier 1 and can provide additional functionalities to the user. Four examples of accessories are shown below.

A first example of accessory 31 is a unit for controlling the electronic magnifier 1 or a pointer-type device, such as a computer mouse, that the user moves with his hand. With this device, the user controls the electronic magnifier 1. The user can thus make a pointer or an arrow appear superimposed on the image of the watchmaking product 3 he is seeing. The user sees the watchmaking product 3 with the arrow in real time thanks to the display screen 9. The composite image is acquired by the acquisition camera 12. This composite image can thus be viewed on the screen 28 of the computer-type machine 27. This image can then be transmitted to other computers connected to the Internet. As another example, the user controls the magnifier to acquire an image or a video, or to begin the “streaming”. It is also possible, for example, to set the intensity of the screen of the electronic magnifier 1.

A second example of accessory 31 is formed by means for recognizing a tool that can be used with the watchmaking product 3. In the case where the watchmaking product 3 is a watch mechanism, the means for recognizing the tool are in the form of a tool holder, able to hold one or several tool(s), such as screwdrivers, pliers, etc. As soon as the user grabs a specific tool present on the tool holder, the tool holder recognizes the type of tool and sends information relating to the tool to the electronic magnifier 1. The communication means 19 of the electronic magnifier 1 communicate with the recognition means to receive the selected information relating to the tool. This information relating to the tool is then transmitted to the computer-type machine 27 and transmitted to the remote server 29.

The data concerning the watchmaking product 3 relate by way of example to all the screws with their specific parameters, such as dimensions, shape of the indentations, tightening torques, specific tools to be used, etc. From the information relating to the received tool, the remote server 29 selects among all the data concerning the watchmaking product 3, at least one information relating to this tool, for example the precise tightening torque of the screw. This information is sent back to the computer-type machine 27, which sends it back to the electronic magnifier 1. The information relating to the specific tool chosen by the user, will be loaded and will be displayed on the display screen 9 of the electronic magnifier 1. The user will have on the display screen 9 the tightening torque of the screw superimposed on the actual image of the mechanism on which the screw must be placed. This composite image can thus be viewed on the screen 28 of the computer-type machine 27. This image can then be transmitted to other computers connected to the Internet.

A third example of accessory 31 is formed by means for recognizing at least one component of the watchmaking product 3. In the case where the watchmaking product 3 is a watch mechanism, the component recognition means are in the form of a component holder, on which one or several component(s) is/are placed, such as cogs, screws, springs, bridges, movement parts, or one or several sub-assembly(ies) already preassembled and made up of several components forming the mechanism, etc As soon as the user grabs a specific component present on the accessory, the accessory recognizes the type of component in question and sends information relating to this component to the electronic magnifier 1. The communication means 19 of the electronic magnifier 1 communicate with the recognition means to receive the selected information relating to the component. This information relating to the component is then transmitted to the computer-type machine 27 which transmits it to the remote server 29.

The data concerning the watchmaking product 3 relate, for example, to the plans and diagrams indicating the precise positioning of the component(s), specific tools to be used, etc. The remote server 29 selects from all the data concerning the watchmaking product 3 at least one information relating to this component. This information is returned to the computer-type machine 27, which returns it to the electronic magnifier 1. The information relating to the component chosen by the user, will be loaded and will be displayed on the display screen 9 of the electronic magnifier 1. The user will have on the display screen 9 the diagram of the positioning of the component of the watch mechanism superimposed on the actual image of the mechanism on which the component must be placed. This composite image can thus be viewed on the screen 28 of the computer-type machine 27. This image can then be transmitted to other computers connected to the Internet.

A fourth example of accessory 31 is a device for measuring parameters concerning the watchmaking product 3. The device is placed next to, against, or on the watchmaking product 3. In the case where the watchmaking product 3 is a watch mechanism, the device integrates a sensor which for example allows measuring the rate, the frequency, the amplitude of the oscillations, the power reserve. The device for measuring parameters returns the measurement information to the electronic magnifier 1. The communication means 19 of the electronic magnifier 1 communicate with the device for measuring parameters to receive the selected information relating to the watchmaking product 3. This information is then transmitted to the computer-type machine 27 which transmits it to the remote server 29.

The data concerning the watchmaking product 3 relate by way of example to the nominal pre-recorded values of the parameters of the watch mechanism. The remote server 29 selects among all the data concerning the watchmaking product 3 at least one information relating to the parameter. This information is sent back to the computer-type machine 27, which sends it back to the electronic magnifier 1. The information relating to the parameter with its nominal value will be loaded and will be displayed on the display screen 9 of the electronic magnifier 1. The user who is a watchmaker will be able to immediately make the settings of the movement of the watch based on the nominal value of the parameters. The user will have on the display screen 9 both the measured value and the nominal value superimposed on the actual image of the mechanism. This composite image can thus be viewed on the screen 28 of the computer-type machine 27. This image can then be transmitted to other computers connected to the Internet.

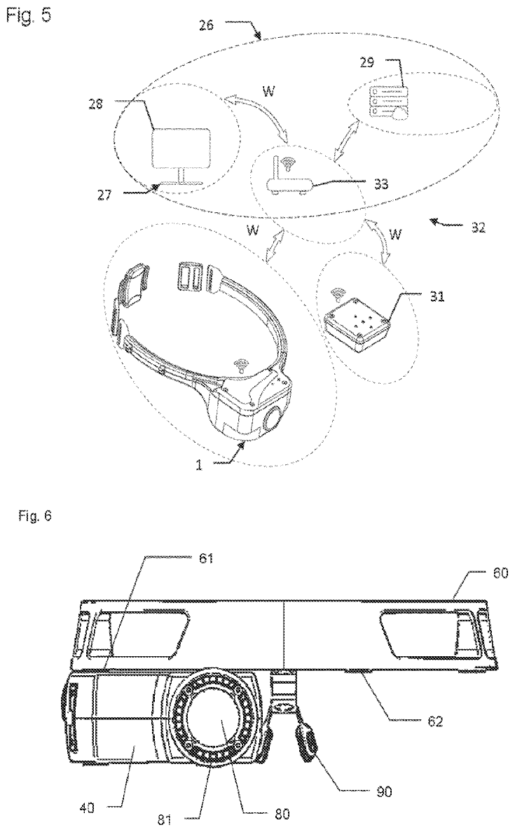

A magnifier assembly 32, according to a second embodiment represented in FIG. 5, comprises the same units as the magnifier assembly 25 according to the first embodiment of FIG. 4, namely the electronic magnifier 1, according to the first embodiment of FIGS. 1 and 2 or according to the second embodiment of FIG. 3, the data processing unit 26 with the computer-type machine 27, provided with its screen 28, the server 29 and the accessory 31. The electronic magnifier 1 and the components 26, 27, 29 and 31 are described in detail above. A wireless router 33 forms a central interface between the communication means 19 of the electronic magnifier 1, the computer-type machine 27, the server 29 and the accessory 31.

In the magnifier assembly 32 of the second embodiment, the wireless router 33 is configured so that the electronic magnifier 1, the computer-like machine 27, the server 29 and the accessory 31 are on the same local area network (LAN). The electronic magnifier 1, the computer-type machine 27 and the accessory 31 communicate with the wireless router 33 using Wi-Fi wireless technology (Arrows W in FIG. 5). If the video data are sent in streaming to the cloud, the wireless router 33 is also connected to a wide area network (WAN). The server 29 communicates with the wireless router 33 through a wired connection.

FIG. 6 represents a front view of a third embodiment for an electronic magnifier, comprising in particular a headband 60, an optoelectronic module 40 and a bearing module 90 with pads to provide a bearing on the nose of the user. It is possible to provide a height setting of the bearing module 90 to adjust the wearing of the electronic magnifier to the morphology of the user.

The headband 60 forms a support frame comprising a left interface 62 and a right interface 61. The optoelectronic module 40 embeds for its part at least one magnifying objective lens with a lens 80, and communication means and/or an acquisition camera and/or a beam splitter embedded in the optoelectronic module 40 can be provided, as for the other embodiments above. This optoelectronic module 40 forms a secondary frame which can also be received both by the left interface 62 and by the right interface 61 (typically via flexible tabs that are reversibly coupled with counterforms) to position the optoelectronic module 40 in front of a right or left eye of the user. It can be noted that the optoelectronic module 40 of FIG. 6 is symmetrical and can be reversed to be coupled with the right interface 61 as well as with the left interface 62.

A setting of the position of the optoelectronic module 40 on the headband 60 can be provided so as to adjust the position in depth or laterally relative to the eye of the user. Runners with wheels and precision screws can be provided for this purpose.

Furthermore, it may be noted that the optoelectronic module 40 comprises, around the lens 80, an annular-shaped lighting module 81, to light an object to be observed without generating shadows. It is possible to use light-emitting diodes distributed along the periphery of the lens 80 to provide regular lighting of the object to be observed.

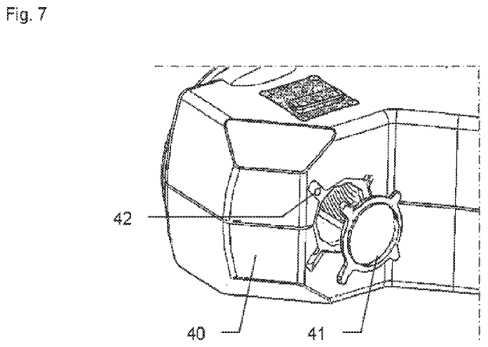

FIG. 7 represents a rear view of the optoelectronic module 40, with a correction lens 41 which can be removably coupled to the optoelectronic module 40, for example via magnets 42. Thus, a user who needs a vision correction can couple a suitable correction lens 81 (myopia, astigmatism, . . . ) to be able to use the electronic magnifier without wearing his glasses. If the user does not need optical correction, the corrective lens 41 can be a simple neutral lens, that is to say a glass without correction.

According to the invention, a method, using the electronic magnifier 1 according to the first or the second embodiment of the respective FIGS. 1, 2 and 3, with the magnifier assembly 32 according to the first or the second embodiment of FIGS. 4 and 5 respectively, allows performing a check on a watchmaking product 3, and in particular in a non-limiting manner a watch mechanism.

The checking method comprises different successive steps. A first step of the checking method consists for the user in observing the watchmaking product 3 with the objective lens 8 of the electronic magnifier 1. A second step of the checking method consists in acquiring at least one image of the watchmaking product 3 thanks to the camera 12 of the electronic magnifier 1. A third step of the checking method consists in sending the acquired image of the watchmaking product to the data processing unit 26, with the computer-type machine 27, which is located in the vicinity of the electronic magnifier 1.

A fourth step of the checking method consists in sending the image of the watchmaking product 3 which was acquired during the second step to a second computer-type machine, which is located remotely from the computer-type machine 27 which is located in the vicinity of the electronic magnifier 1. During the check, a beginner watchmaker equipped with the electronic magnifier 1 will be able to request the assistance of a senior watchmaker located remotely.

A fifth step of the checking method consists in sending to the data processing unit 26, the computer-type machine 27 and/or to the server 29 the acquired image of the watchmaking product 3. The data processing unit 26 with the server 29 is programmed to recognize the watchmaking product 3, by performing a comparison between the acquired image of the watchmaking product and data concerning the watchmaking product 3. This allows automatic recognition of the reference of the watch and/or the caliber. A sixth step of the checking method consists in displaying the data concerning the watchmaking product 3 on the display screen 9 of the electronic magnifier 1. In this sixth step, the maintenance plan or other important information, such as strengths and weaknesses of the caliber, precautions to be taken are displayed on the display screen 9. The display screen 9 can also display the 3D CAD file for the purpose of comparing the watch or the caliber under check with the theoretical design.

A seventh optional step of the checking method consists in recognizing a tool to be used with the watchmaking product 3, to generate at least one information relating to the tool. This recognition step is implemented using a recognition accessory 31 connected to the electronic magnifier 1. An eighth optional step of the checking method consists in displaying the information relating to the tool generated on the display screen 9 of the electronic magnifier 1.

A ninth optional step of the checking method consists in recognizing at least one component of the watchmaking product 3, to generate at least one information relating to the component of the watch mechanism. This recognition step is implemented using a recognition accessory 31 connected to the electronic magnifier 1. A tenth optional step of the checking method consists in displaying the information relating to the component of the watchmaking product 3 generated on the display screen 9 of the electronic magnifier 1.

On a non-limiting basis, the data comprise in particular:
information identifying the watchmaking product 3, and/or
technical information on the watchmaking product 3, and/or
information identifying a subset of the watchmaking product 3, and/or
information identifying a component of the watchmaking product 3, and/or
information identifying a stage of mounting the watchmaking product 3.

Various modifications and/or improvements can be made by those skilled in the art to the various embodiments of the invention described in the present description without departing from the scope of the invention. Particularly, the recognition of the tools or components can be performed using an image recognition software based on the shape of the tools or components visible on the images from the acquisition camera. The use of QR-codes printed on the tools or the packagings of the components can also be envisaged.

1. An electronic watchmaker magnifier, intended to observe a watchmaking product, in particular a watch mechanism, provided with:
a magnifying objective lens, to observe the watchmaking product,
communication means, to receive and/or send data,
at least one of:
a display screen, to display the data, and
an acquisition camera, to acquire at least one image of the watchmaking product,
a beam splitter, provided:
to simultaneously direct towards a user's eye at least one image of the watchmaking product coming from the magnifying objective lens and at least one image from the display screen, and/or
to simultaneously direct towards a user's eye and towards the acquisition camera at least one image of the watchmaking product coming from the magnifying objective lens.

2. The electronic magnifier according to claim 1, wherein the communication means are provided to send to a remote user the image of the watchmaking product acquired by the acquisition camera, the beam splitter being provided to simultaneously direct towards the acquisition camera at least one image of the watchmaking product coming from the magnifying objective lens and at least one image from the display screen.

3. The electronic magnifier according to claim 2, wherein the beam splitter comprises a semi-reflecting mirror to split the image of the display screen into a first refracted portion directed towards the camera and a second reflected portion directed towards the eye of the user, and/or to split the image of the watchmaking product coming from the magnifying objective lens, into a first refracted portion directed towards the eye of the user and a second reflected portion directed towards the acquisition camera.

4. An electronic watchmaker magnifier assembly, intended to observe a watchmaking product, in particular a watch mechanism, comprising:
a data processing unit, having data, and
the electronic magnifier, according to claim 2, the communication means of the electronic magnifier communicating with the data processing unit, to receive the data and/or to send to the data processing unit the image of the watchmaking product acquired by the acquisition camera.

5. The magnifier assembly according to claim 4, comprising means for controlling the electronic magnifier, the communication means of the electronic magnifier communicating with the controlling means.

6. The magnifier assembly according to claim 4, comprising means for recognizing a tool to be used with the watchmaking product, to select from the data concerning the watchmaking product at least one information relating to the tool, the communication means of the electronic magnifier communicating with the recognition means to receive the selected information relating to the tool, so as to display the information relating to the tool on the display screen of the electronic magnifier.

7. The magnifier assembly according to claim 4, comprising means for recognizing at least one component of the watchmaking product, to select from data concerning the watchmaking product at least one information relating to the component, the communication means of the electronic magnifier communicating with the recognition means to receive the selected information relating to the component, so as to display the information relating to the component on the display screen of the electronic magnifier.

8. The magnifier assembly according to claim 4, comprising a device for measuring parameters concerning the watchmaking product.

9. The magnifier assembly according to claim 4, wherein the data processing unit comprises a computer-type machine connected with a server.

10. The magnifier assembly according to claim 9, wherein the computer-type machine is connected to an external computer network.

11. The magnifier assembly according to claim 4, further comprising a wireless router, forming an interface between the communication means of the electronic magnifier, and/or the data processing unit and/or the recognition means and/or the measurement device.

12. The magnifier assembly according to claim 4, wherein the data comprise in particular:
information identifying the watchmaking product, and/or
technical information about the watchmaking product, and/or
information identifying a subset of the watchmaking product, and/or
information identifying a component of the watchmaking product, and/or
information identifying a stage of mounting the watchmaking product.

13. A method for performing a check on a watchmaking product, in particular a watch mechanism, comprising the steps consisting in:
observing the watchmaking product with an objective lens of an electronic magnifier,
acquiring at least one image of the watchmaking product with a camera of the electronic magnifier, and
sending the acquired image of the watchmaking product to a computer-type machine in the vicinity of the electronic magnifier.

14. The method according to claim 13, further comprising the step consisting in sending the acquired image of the watchmaking product to a second computer-type machine, remote from the computer-type machine in the vicinity of the electronic magnifier.

15. The method according to claim 12, further comprising the steps consisting in:
sending to a data processing unit the acquired image of the watchmaking product, the data processing unit being programmed to recognize the watchmaking product, by comparison between the acquired image of the watchmaking product and data concerning the watchmaking product, and
displaying the data concerning the watchmaking product on a display screen of the electronic magnifier.

16. The method according to claim 13, further comprising the steps consisting in:
recognizing a tool to be used with the watchmaking product, to generate at least one information relating to the tool, and
displaying the information relating to the tool generated on the display screen of the electronic magnifier.

17. The method according to claim 13, further comprising the steps consisting in:
recognizing at least one component of the watchmaking product, to generate at least one information relating to the component of the watchmaking product, and
displaying the information relating to the component of the watchmaking product generated on the display screen of the electronic magnifier.

18. The electronic magnifier according to any of claims 1 to 3, comprising lighting means for illuminating or lighting the watchmaking product.
